(19) United States
(12) Patent Application Publication
(10) Pub. No.: US 2007/0102441 A1
(43) Pub. Date: May 10, 2007

(54) Component supplying apparatus and component supplying method

(75) Inventors: Masanao Fujii, Kawasaki (JP); Masaharu Suzuki, Kawasaki (JP); Koichi Shimamura, Kawasaki (JP); Yoshihisa Kamiya, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/360,627

(22) Filed: Feb. 24, 2006

(30) Foreign Application Priority Data
Nov. 8, 2005 (JP) 2005-323841

(51) Int. Cl. B65G 65/00; B65G 47/00

(52) U.S. Cl. 221/174

(57) ABSTRACT

A disclosed component supplying apparatus includes a component installment part for installing one or more components therein, a blowout port including an opening from which air is blown into the component installment part, and a component supply part into which the components are guided from the component installment part by the air from the blowout port. The component supply part is provided in communication with an upper end part of a sidewall of the component installment part.

### BACKGROUND OF THE INVENTION

1. Field of the Invention

The present invention generally relates to a component supplying apparatus and a component supplying method, and more particularly to a component supplying apparatus and a component supplying method for supplying one or more components from a component installment chamber to a component supply part.

2. Description of the Related Art

In a case of mounting small-sized components (e.g. screws, bushes, chips) to a substrate or the like, the components are typically supplied in an aligned manner by using a component supplying apparatus. Thereby, automation for mounting the components can be achieved and the efficiency for mounting/assembling the components can be improved.

Such a component supplying apparatus is provided in various types. In one example, a component supplying apparatus is installed with components that are aligned beforehand on a tray, an embossed tape, or a stick so that the components can be supplied in an aligned state.

In another example, a component supplying apparatus is provided with a component installment chamber for installing components therein, in which the components are aligned by oscillating the component installment chamber. In another example, a component supplying apparatus uses gravity for aligning and guiding components into a supply tube provided at a lower portion thereof. In another example, a component supplying apparatus having a drum-shaped rotating component installment chamber uses centrifugal force for aligning and guiding components into a supply tube.

However, the above-described apparatus (method) for supplying components with a tray, an embossed tape, or a stick is uneconomical since it incurs costs for preparing the tray, the embossed tape, or the stick for aligning the components. In addition, such tray or the like consumes a large amount space and is unsuitable for a small-size desktop apparatus.

Furthermore, although the component supplying apparatus having the oscillating component installment chamber may be able to supply components of various shapes, such a component supplying apparatus requires an oscillation generating apparatus, thereby resulting in an over-sized component supplying apparatus. Furthermore, the component supplying apparatuses using gravity or centrifugal force are unable to supply components such as long chip components or screws since such components are liable to become jammed inside the supply tube. In addition, the component supplying apparatuses using gravity or centrifugal force tend to be expensive owing to the fact that they require a complicated mechanism.

### SUMMARY OF THE INVENTION

It is a general object of the present invention to provide a component supplying apparatus and a component supplying method that substantially obviate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a component supplying apparatus and a component supplying method particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a component supplying apparatus including: a component installment part for installing one or more components therein; a blowout port including an opening from which air is blown into the component installment part; and a component supply part into which the components are guided from the component installment part by the air from the blowout port; wherein the component supply part is provided in communication with an upper end part of a sidewall of the component installment part.

Furthermore, an embodiment of the present invention provides a component supplying method using a component supplying apparatus including a component installment part, a blowout port, and a component supply part, the method including the steps of: installing one or more components in the component installment part; blowing air into the component installment part from an opening of the blowout port; and guiding the components into the component supply part from the component installment part by the air from the blowout port; wherein the component supply part is provided in communication with an upper end part of a sidewall of the component installment part.

Furthermore, an embodiment of the present invention provides a component supplying apparatus including: an apparatus body including a top plate and a component installment part for installing one or more components therein; a blowout port including an opening from which air is blown into the component installment part; a lid member provided above the component installment part; and a component supply part into which the components are guided from the component installment part by the air from the blowout port; wherein the component supply part is provided in communication with an upper end part of a sidewall of the component installment part.

Other objects and further features of the present invention will be apparent from the following detailed description when read in conjunction with the accompanying drawings.

### BRIEF DESCRIPTION OF THE DRAWINGS

FIG. 1 is a perspective view showing a main portion of a component supplying apparatus according to a first embodiment of the present invention;

FIG. 2 is a cross-sectional view showing a main portion of a component supplying apparatus according to the first embodiment of the present invention;

FIG. 3A is a perspective view showing a main portion of a component supplying apparatus according to a second embodiment of the present invention;

FIG. 3B is a plan view showing the component supplying apparatus according to the second embodiment of the present invention;

FIG. 4A is a perspective view showing a main portion of a component supplying apparatus according to a third embodiment of the present invention;

FIG. 4B is a plan view showing the component supplying apparatus according to the third embodiment of the present invention;

FIG. 5 is a perspective view showing a main portion of a component supplying apparatus according to a fourth embodiment of the present invention;

FIG. 6 is a cross-sectional view of a component supplying apparatus according to a fifth embodiment of the present invention;

FIG. 7 is a cross-sectional view of a main portion of a component supplying apparatus according to a sixth embodiment of the present invention;

FIG. 8 is a cross-sectional view of a main portion of a component supplying apparatus according to a seventh embodiment of the present invention;

FIG. 9 is a cross-sectional view showing an exemplary configuration of a component supply port according to an embodiment of the present invention (Part 1); and

FIG. 10 is a cross-sectional view showing an exemplary configuration of another component supply port according to an embodiment of the present invention (Part 2).

### DESCRIPTION OF THE PREFERRED EMBODIMENTS

In the following, embodiments of the present invention will be described with reference to the accompanying drawings.

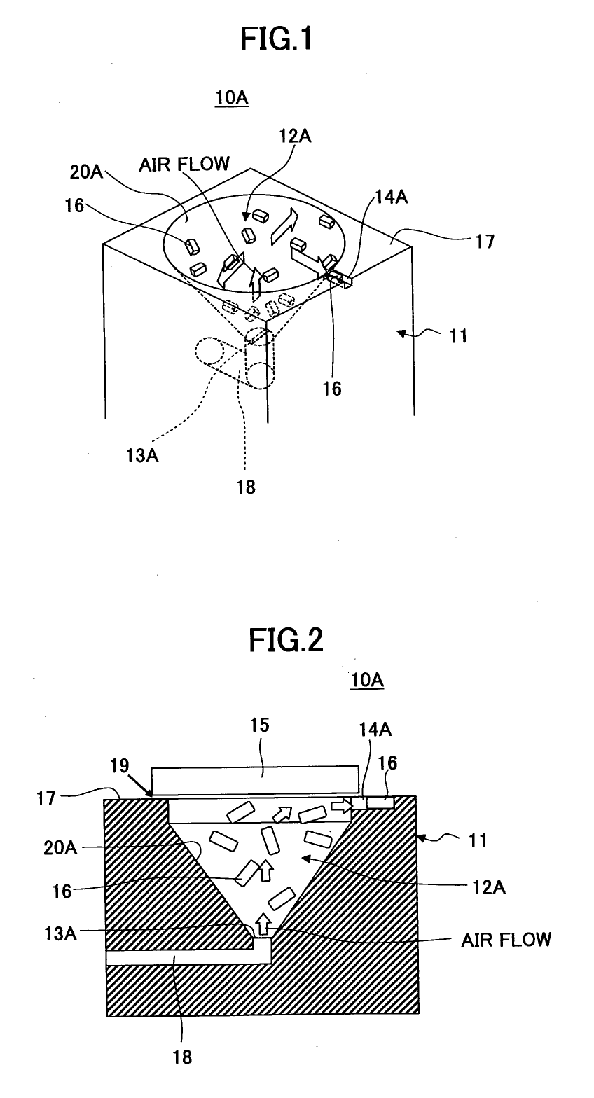

FIGS. 1 and 2 show a component supplying apparatus 10A according to the first embodiment of the present invention. The component supplying apparatus 10A according to the first embodiment of the present invention includes, for example, an apparatus body 11, a component installment chamber 12A, a blowout port 13A, a component supply port 14A, and a lid member 15.

The apparatus body 11 is formed as a casing. The apparatus body 11 includes a top plate 17 provided at an upper portion thereof and the component installment chamber 12A provided at an opening formed in the top plate 17. The component installment chamber 12A is a portion into which one or more components 16 are installed. The component installment chamber 12A has a shape of a funnel. Accordingly, the component installment chamber 12A has a sidewall (slope) 20A that is inclined. The component installment chamber 12A has a bottom plane at which the blowout port 13A is provided.

The blowout port 13A has an opening which is formed as a slit. In this example, the opening of the blowout port 13A has a rectangular shape instead of a round shape. The blowout port 13A is connected to one end of an air guiding passage 18 formed inside the apparatus body 11.

The other end of the air guiding passage 18 is connected to a compressor (not shown) that generates compressed air. Accordingly, the compressed air generated by the compressor is blown out into the component installment chamber 12A from the blowout port 13A via the air guiding passage 18. The compressed air is blown toward the components 16 such that the components 16 are lifted inside the component installment chamber 12A.

Since the compressor may be provided outside of the apparatus body 11, the apparatus body 11 according to this embodiment of the present invention has the component installment chamber 12A, the blowout port 13A, and the air guiding passage 18 provided therein. Thereby, size-reduction as well as cost-reduction can be achieved for the component supplying apparatus 10A. Although there are various commercially available compressors, any type of compressor may be employed as long as the compressor can generate compressed air for sufficiently lifting the components 16 inside the component installment chamber 12A.

The component supply port 14A is provided at the top plate of the apparatus body 11. The component supply port 14A is formed as a groove. More specifically, the component supply port 14A includes an inside end part that is in communication with an upper rim of the side wall 20A of the component installment chamber 12 and an outside end part that is provided as an opening at an outside wall of the apparatus body 11. When the compressed air is blown into the component installment chamber 12, the components 16 inside the component installment chamber 12A are guided into the inside end part of the component supply port 14A and are delivered out from the outside end part of the component supply port 14A, for example, to an assembly person that assembles (mounts) the components 16 and/or to an assembly apparatus (mounting apparatus) that performs an assembling operation (mounting operation) (described in detail below).

The lid member 15 is situated above the top plate 17 of the apparatus body 11. The lid member 15 has a disk shape and is positioned in a manner covering the upper opening part of the component installment chamber 12. Being positioned in this state, the lid member 15 also covers a part of the component supply port 14A. Furthermore, the lid member 15 is positioned on the apparatus body 11 in a manner that a clearance 19 of approximately 0.05 mm is obtained between the top plate 17 and the lid member 15.

Next, the operation of the component supplying apparatus 10A according to the first embodiment of the present invention is described.

In performing a component supplying operation with the component supplying apparatus 10A, first, the lid member 15 is opened and the one or more components 16 are installed (placed) in the component installment chamber 12A. At this stage, the compressor is in a deactivated state. Therefore, the blowing of the compressed air is stopped.

When the installing of the components 16 is completed, the lid member 15 is mounted in a manner so that the clearance 19 can be provided at an upper part of the top plate 17 of the apparatus body 11. Then, the compressor is activated to allow compressed air to be blown into the component installment chamber 12A from the blowout port 13A via the air guiding passage 18. Thereby, the components 16 installed in the component installment chamber 12A are lifted from the lower to the upper portion of the component installment chamber 12A by the flow of the compressed air from the blowout port 13A.

By guiding the compressed air into the component installment chamber 12A, the pressure inside the component installment chamber 12A becomes higher than atmospheric pressure. Accordingly, the air inside the component installment chamber 12A flows out of the component installment chamber 12A from the component supply port 14A being in communication with the component installment chamber 12A and from the clearance 19 provided between the lid member 15 and the top plate 17.

Since the components 16 inside the component installment chamber 12A move along the flow of the compressed air, at least a portion of the components are guided into the component supply port 14A. The component supply port 14A is formed with a shape corresponding to the shape of the components 16.

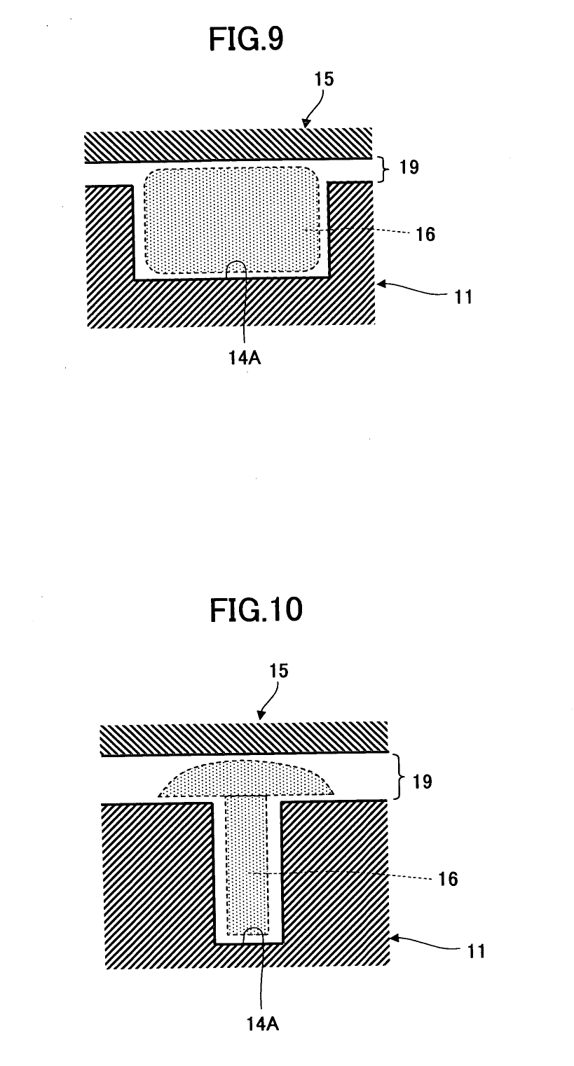

More specifically, in a case where the components 16 are chip components having a rectangular shape, the component supply port 14A is formed having a rectangular cross section corresponding to the shape of the components 16 (the cross section being formed slightly larger than the size of the components 16) as shown in FIG. 9. In another case where the components 16 are screw components, the component supply port 14A is formed having a narrow groove cross section corresponding to the stem part of the screw component 16 (the cross section being formed slightly larger than the size of the stem part of the screw component 16) as shown in FIG. 10. In addition, the clearance 19 is set having a height greater than the height of the head part of the screw component 16 as shown in FIG. 10.

Among the components 16 which are lifted to the inside end part of the component supply port 14A (opening of the component supply port 14A provided at the sidewall 20A), the components 16 that are oriented in a position matching the shape of the component supply port 14A can be guided into the component supply port 14A owing to the fact that the component supply port 14A is suitably formed with a shape corresponding to the shape of the components 16. Therefore, the components 14A that enter the component supply port 14A are aligned having the same position (orientation). Accordingly, each component 16 is delivered out of the apparatus body 11 from the outside end part of the component supply port 14A (opening of the component supply port 14A provided at the outside wall of the apparatus body 11) having the same relative position (orientation).

Hence, the component supplying apparatus 10A according to the first embodiment of the present invention is configured to lift the components 16 with compressed air and guide the lifted components 16 into the component supply port 14A. Therefore, a satisfactory component supplying operation as well as size-reduction of the apparatus body 11 can be achieved with the above-described component supplying apparatus 10A provided with a simple configuration.

Since the component installment chamber 12A according to the first embodiment of the present invention has a funnel shape, the lifted components 16 falling from the upper portion of the component installment chamber 12A gather at a center part of the bottom portion of the component installment chamber 12A. The center part at which the components 16 gather is the area where the blowout port 13A is provided. The blowout port 13A, which is formed as a slit, has a shape that makes it difficult for the components 16 to remain thereon. Accordingly, the fallen components 16 can be efficiently re-lifted, to thereby improve the efficiency for guiding the components 16 to the component supply port 14A.

Since the clearance 19 is provided between the top plate 17 of the apparatus body 11 and the lid member 15, the compressed air, which is guided into the component installment chamber 12A, can flow out of the component installment chamber 12A not only through the component supply port 14A but also through the clearance 19. Therefore, the lifted components 16 (or at least a-portion of the lifted components 16) are aligned in a state being absorbed (evacuated) along the clearance 19 between the lid member 15 and the top plate 17.

The lifted components 16 are gradually conveyed in an absorbed state along the clearance 19 by the compressed air flowing through the clearance 19 and are guided into the component supply port 14A upon reaching the inside end part of the component supply port 14A. Since it is relatively rare for the lifted components 16 to be guided directly into the component supply port 14A, a large portion of the lifted components 16 are guided into the component supply port 14A by being conveyed along the clearance 19. Accordingly, the clearance 19 enables the components 16 to be smoothly guided into the component supply port 14A.

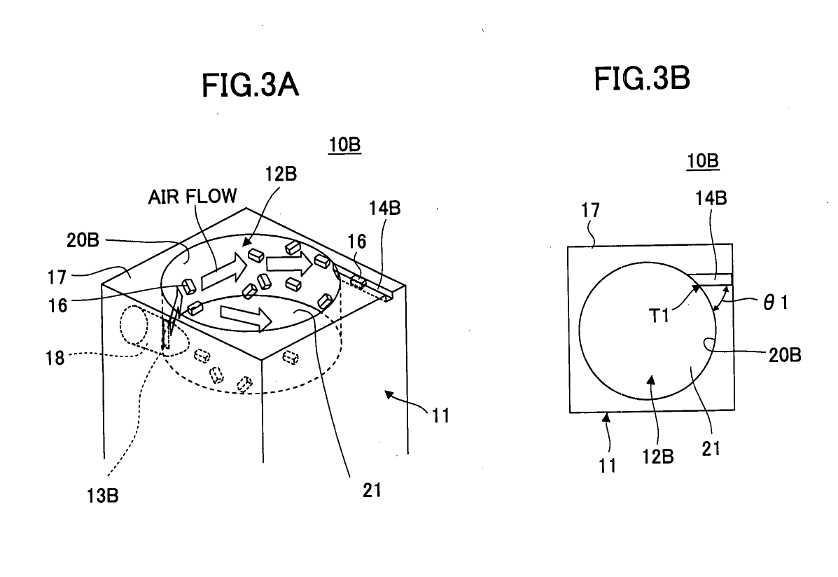

Next, the second to seventh embodiments of the present invention are described with reference to FIGS. 3A-8.

FIGS. 3A and 3B each show a component supplying apparatus 10B according to the second embodiment of the present invention. FIG. 3A is a perspective view of the component supplying apparatus 10B. FIG. 3B is a plan view of the component supplying apparatus 10B. In FIGS. 3A and 3B, like components are denoted by like numerals as of FIGS. 1 and 2 and are not described in further detail.

In the above-described component supplying apparatus 10A according to the first embodiment of the present invention, the apparatus body 11 includes a funnel shaped component installment chamber 12A having a blowout port 13A at a bottom portion thereof. In the component supplying apparatus 10B according to the second embodiment of the present invention, the apparatus body 11 includes a cylindrical shaped component installment chamber 12B. Furthermore, the component installment chamber 12B includes a blowout port 13B provided at a sidewall (inner wall) 20B of the component installment chamber 12B.

The blowout port 13B is formed as a slit that is elongated in a vertical direction. The opening of the blowout port 13B is provided in the sidewall 20B of the component installment chamber 12B. The opening of the blowout port 13B is located approximately at a middle part (in the height direction) of the sidewall 20B of the component installment chamber 12B. The component supply chamber 12B has a shape substantially of a circle according to the plan view shown in FIG. 3B. Furthermore, as shown in FIG. 3B, the component supply port 14B is situated approximately at a position to which a line that is tangent to the circle extends.

When the compressor (not shown) is activated after the components 16 are installed in the component installment chamber 12B, compressed air is blown into the component installment chamber 12B from the blowout port 13B via the air guiding passage 18. Thereby, the components 16 installed in the component installment chamber 12B are lifted from the lower to upper portion of the component installment chamber 12B by the flow of the compressed air from the blowout port 13B.

Since the blowout port 13B according to the second embodiment of the present invention is provided at the sidewall (inner wall) 20B of the cylindrical shaped component installment chamber 12B, the compressed air flows in a manner circling along the inner wall 20B of the component installment chamber 12B. Accordingly, the components 16 are moved by the flow of the compressed air along the inner wall 20B of the component installment chamber 12B.

Since the component supply port 14B is provided at a position to which a tangential line of the circle of the component installment chamber 12B extends, the components 16 (or at least a portion of the components 16) circling along the inner wall 20B of the component installment chamber 12B are guided into the component supply port 14B together with the compressed air upon reaching the opening of the component supply port 14B.

In the component supplying apparatus according to the second embodiment of the present invention, since the component supply port 14B is situated in a position to which a tangential line of the circle (inner circular peripheral) of the component installment chamber 12B extends, the components 16 circling along the inner wall 20B of the component installment chamber 12B have a velocity element with respect to the direction of the tangential line of the circle of the component installment chamber 12B. Accordingly, the components 16 circling along the inner wall 20B of the component installment chamber 12B are smoothly guided into the component supply port 14B upon reaching the inside end part of the component supply port 14B. Thereby, the efficiency for guiding the components 16 into the component supply port 14A can be improved.

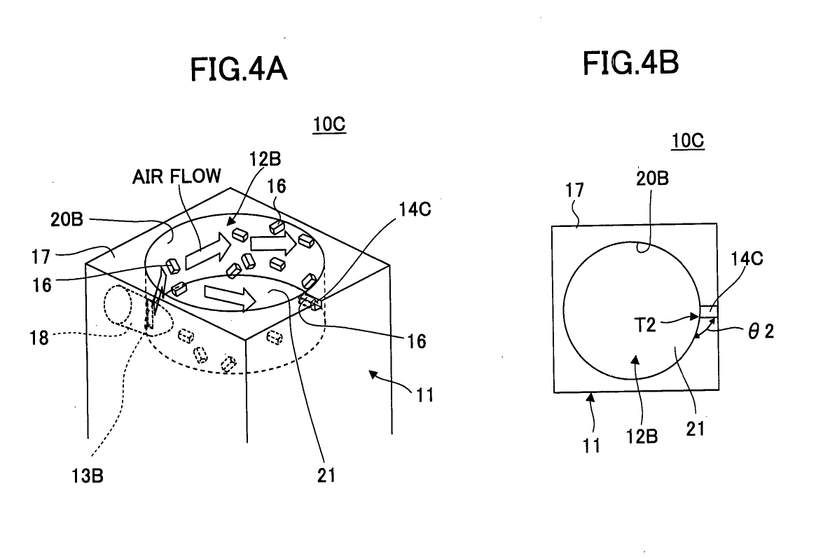

FIGS. 4A and 4B each show a component supplying apparatus 10C according to the third embodiment of the present invention. FIG. 4A is a perspective view of the component supplying apparatus 10C. FIG. 4B is a plan view of the component supplying apparatus 10C. In FIGS. 4A and 4B, like components are denoted by like numerals as of FIGS. 1-3B and are not described in further detail.

The component supplying apparatus 10C according to the third embodiment of the present invention has a configuration that is substantially the same as that of the component supplying apparatus 10B of the second embodiment. However, although the component supply port 14B of the second embodiment is situated in a position to which a tangential line of the circle of the component installment chamber 12B extends, the component supply port 14C of third embodiment is situated in a position to which a normal line of the circle of the component installment chamber 12C extends.

With the configuration of the third embodiment, the angle between an inner groove wall of the component supply port 14C (an inner groove wall of the component supply port 14C situated at a downstream side with respect to the flow of the compressed air) and the sidewall 20B of the component installment chamber 12B (indicated with a double-headed arrow θ2 in FIG. 4B) can be larger compared to that of the component supplying apparatus 10B of the second embodiment (indicated with a double-headed arrow θ1 in FIG. 3B).

In other words, the angle between an inner groove wall of the component supply port 14B (an inner groove wall of the component supply port 14B situated at a downstream side with respect to the flow of the compressed air) and the sidewall 20B of the component installment chamber 12B (as indicated with the double-headed arrow θ1 in FIG. 3B) is more acute than that of the component supplying apparatus of the third embodiment, since the component supply port 14B of the second embodiment is situated in a position to which a tangential line of the circle of the component installment chamber 12B extends. Furthermore, in the above-described configuration of the second embodiment, the opening of the component supply port 14B, which is provided at the sidewall 20B of the component installment chamber 12B, has a relatively large area (size of the opening). This increases the probability that the components 16 circling along the sidewall 20B will collide with an inner end part T1 (see FIG. 3B) of the component supply port 14B upon reaching the inner end part T1 of the component supply port 14B.

In the configuration of the third embodiment, the angle θ2 between the inner groove wall of the component supply port 14C and the sidewall 20B becomes greater than the angle θ1 between the inner groove wall of the component supply port 14B and the sidewall 20B (θ2>θ1) owing to the fact that the component supply port 14C is situated in a position to which a normal line of the circle of the component installment chamber 12C extends. Accordingly, this reduces the probability that the components 16 circling along the sidewall 20B will collide with an inner end part T2 (see FIG. 4B) of the component supply port 14C upon reaching the inner end part T2 of the component supply port 14C. Accordingly, the components 16 can be prevented from being caught or deflected at the inner end part T2 of the component supply port 14C. Thereby, the efficiency for guiding the components 16 to the component supply port 14C can be improved.

FIG. 5 shows a component supplying apparatus 10D according to the fourth embodiment of the present invention. In FIG. 5, like components are denoted by like numerals as of FIGS. 1-4B and are not described in further detail.

The component supplying apparatus 10D according to the fourth embodiment of the present invention has a configuration that is substantially the same as that of the component supplying apparatus 10B of the second embodiment. In the component supplying apparatus 10B of the second embodiment, the depth of the component installment chamber 12B is relatively shallow, and the opening of the blowout port 13B is situated in the proximity of a bottom plane 21 of the component installment chamber 12B (see FIG. 3A). However, in the component supplying apparatus 10C of the fourth embodiment, the component installment chamber 12C has a depth that is greater than that of the component installment chamber 12B of the second embodiment.

More specifically, the component installment chamber 12C has a space area 27 provided at a position lower than the opening of the blowout port 13B. In the fourth embodiment of the present invention, the height (depth) of the space area 27 is indicated with an arrow H in FIG. 5. Accordingly, by providing the space area 27 at a position lower than the opening of the blowout port 13B, the capacity for installing the components 16 inside the component installment chamber 12C can be increased while still being able to have the components 16 satisfactorily circle along the sidewall 20B of the component installment chamber 12C.

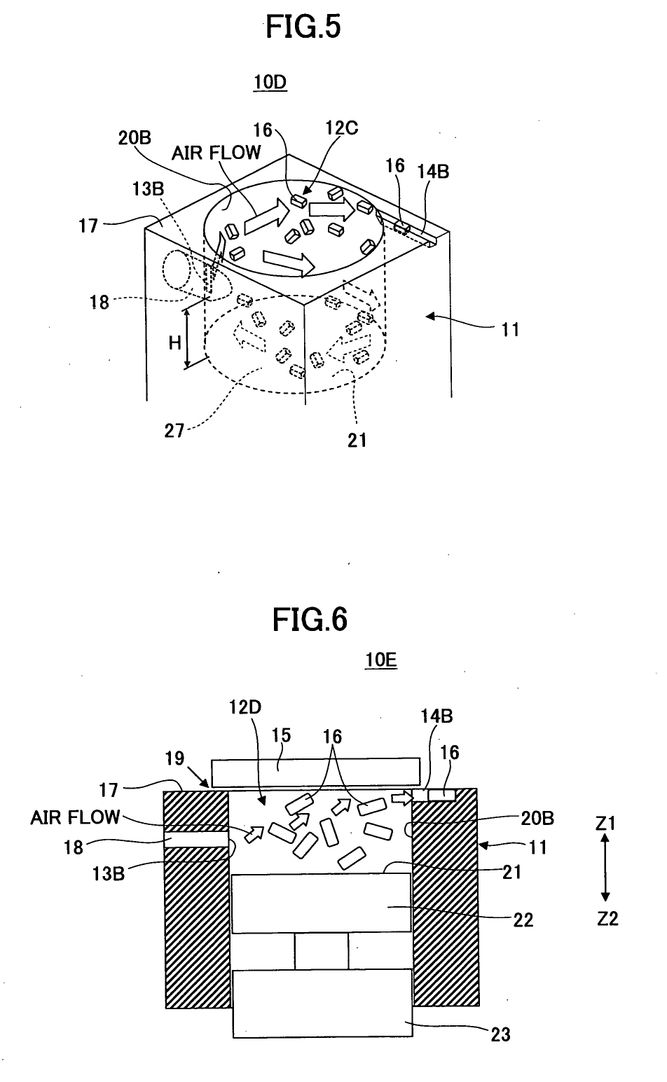

FIG. 6 shows a component supplying apparatus 10E according to the fifth embodiment of the present invention. In FIG. 6, like components are denoted by like numerals as of FIGS. 1-5 and are not described in further detail.

The component supplying apparatus 10E according to the fifth embodiment of the present invention has a configuration such that the bottom plate 22 provided at a bottom portion of a component installment chamber 12D can be raised and lowered with respect to the blowout port 13B. More specifically, an actuator 23 is provided below the bottom plate 22 of the component installment chamber 12D. Accordingly, the actuator 23 raises and lowers the bottom plate 22 in the vertical direction (arrow directions Z1-Z2 shown in FIG. 6). It is to be noted that the actuator 23 is configured to raise and lower the bottom plate 22 to an extent of not interfering with the compressed air flowing out from the blowout port 13B. That is, the upper limit of elevating (raising/lowering) the bottom plate 22 with the actuator 23 is the position (level) at which the blowout port 13B is provided.

Accordingly, with the component supplying apparatus 10E, the capacity of the component installment chamber 12D can be adjusted in correspondence with the amount of components 16 to be installed in the component installment chamber 12D by raising and lowering the bottom plate 22 (bottom plane 21) of the component installment chamber 12D with the actuator 23. Furthermore, even in a case where the components 16 have a large amount of weight that they are difficult to lift with compressed air, the components 16 can be lifted by lifting the bottom plane 21 to a position closer to the blowout port 13B. Accordingly, a steady component supplying operation can be achieved even in a case where the components 16 are heavy.

FIG. 7 shows a component supplying apparatus 10F according to the sixth embodiment of the present invention. In FIG. 7, like components are denoted by like numerals as of FIGS. 1-6 and are not described in further detail.

The component supplying apparatus 10F according to the sixth embodiment of the present invention has a configuration in which a component installment chamber 12E is provided with a cylindrical part 24 and a funnel part 25. Furthermore, the component installment chamber 12E includes two blowout ports 13A and 13B. As shown in FIG. 7, the funnel part 25 is provided below the cylindrical part 24. The blowout port 13A is formed at a bottom portion of the funnel part 25. The cylindrical part 24 is formed in a manner continuing from an upper portion of the funnel part 25. The blowout port 13B is formed at the sidewall 20B of the cylindrical part 24.

With this configuration, the components 25 installed or falling into the funnel part 25 are lifted to the cylindrical part 24 by the compressed air blowing out from the blowout port 13A. Then, when the lifted components 16 reach the cylindrical part 24, the compressed air blowing out from the blowout port 13B guides the components 16 along the sidewall 20B of the cylindrical part 24. Accordingly, the components 16 in the funnel part 25 can be reliably lifted to the cylindrical part 24 and guided into the component supply port 14B. Thereby, a steady component supplying operation can be achieved.

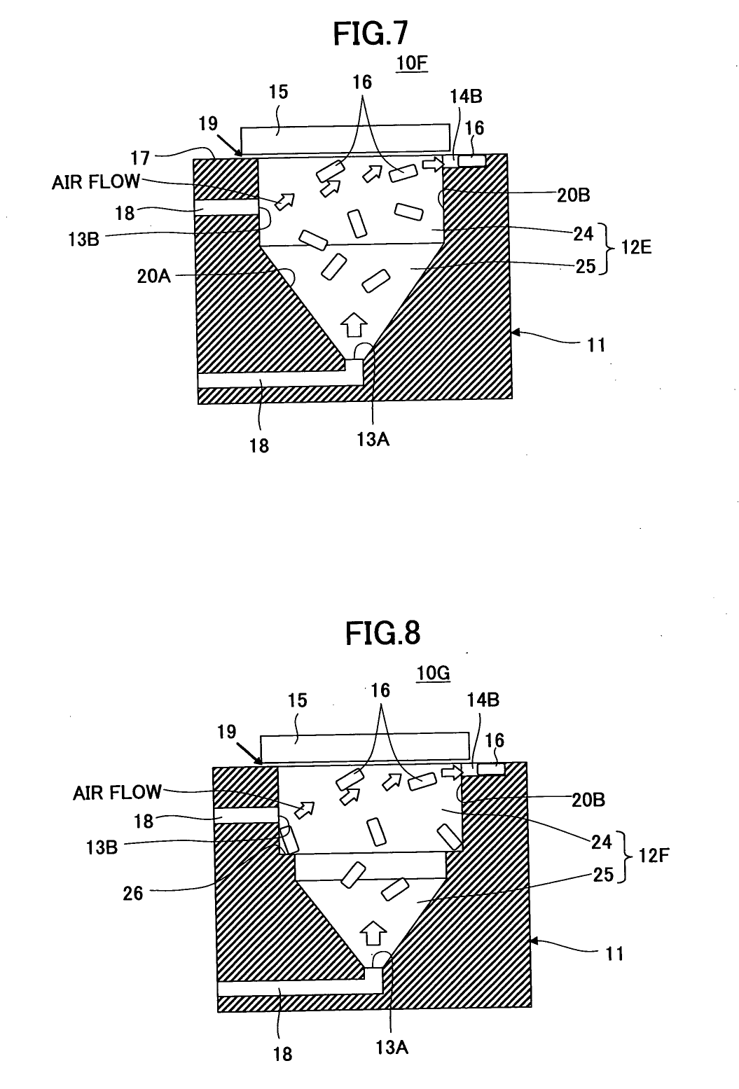

FIG. 8 shows a component supplying apparatus 10G according to the seventh embodiment of the present invention. In FIG. 8, like components are denoted by like numerals as in FIGS. 1-7 and are not described in further detail.

In the component supplying apparatus 10F according to the sixth embodiment of the present invention, the cylindrical part 24 is formed in a manner continuing from the funnel part 25. Meanwhile, in the component supplying apparatus 10G according to the seventh embodiment of the present invention, a step part 26 is provided at the sidewall 20B of the component installment chamber 12F between the blowout port 13A and the blowout port 13B.

The step part 26 is formed with a shape and size that allow one or more components 16 to be placed thereon. Although the step part 26 in this embodiment is provided in a manner encircling the sidewall 20B, the step part 26 may also be provided in an intermittent manner along the sidewall 20B. It is to be noted that the step part 26 may also be a member that projects inward from the sidewall 20B of the component installment chamber 12F (e.g. protrusion, boss).

Accordingly, by providing the step part 26 at a position between the two blowout ports 13A and 13B, a portion of the components 16 falling towards the funnel part 25 can be caught at the step part 26 instead of falling to the bottom portion of the funnel part 25. Therefore, the components 16 that are caught at the step part 26 can be lifted from the step part 25 (which is situated higher than the bottom portion of the funnel part 25) instead of being lifted up from the bottom portion of the funnel part 25. That is, instead of lifting the components 16 up from the bottom portion of the funnel part 25, a portion of the components 16 can be lifted from a position closer to the component supply port 14B. Thereby, the components 16 can be lifted by the blowing compressed air with greater efficiency.

Although the components 16 in the above-described embodiments of the present invention are described by using chip components and screws as examples, other types of small-sized components may also be employed.

In the component supplying apparatus according to the above-described embodiments of the present invention, the compressor is provided as an independent member that is separate from the component supplying apparatus for the purpose of reducing the size of the component supplying apparatus and for allowing various types of compressor to be connected to the component supplying apparatus. Nevertheless, the compressor may also be provided as a built-in member of the component supplying apparatus.

Further, the present invention is not limited to these embodiments, but variations and modifications may be made without departing from the scope of the present invention.

The present application is based on Japanese Priority Application No. 2005-323841 filed on Nov. 8, 2005, with the Japanese Patent Office, the entire contents of which are hereby incorporated by reference.

What is claimed is:

1. A component supplying apparatus comprising:
a component installment part for installing one or more components therein;
a blowout port including an opening from which air is blown into the component installment part; and
a component supply part into which the components are guided from the component installment part by the air from the blowout port;
wherein the component supply part is provided in communication with an upper end part of a sidewall of the component installment part.

2. The component supplying apparatus as claimed in claim 1, wherein a clearance is provided in the vicinity of the upper end part of the sidewall of the component installment part for releasing a portion of the air from the blowout port.

3. The component supplying apparatus as claimed in claim 1, wherein the component installment part has a funnel shape, wherein the blowout port is situated at a bottom plane of the component installment part.

4. The component supplying apparatus as claimed in claim 1, wherein the component installment part has a cylindrical shape, wherein the blowout port is situated at the sidewall of the component installment part.

5. The component supplying apparatus as claimed in claim 1, wherein the component supply part is situated at a position to which a tangential line of an inner circular peripheral of the component installment part extends.

6. The component supplying apparatus as claimed in claim 1, wherein the component supply part is situated at a position to which a normal line of an inner circular peripheral of the component installment part extends.

7. The component supplying apparatus as claimed in claim 4, wherein a space area is at a position lower than the opening of the blowout port.

8. The component supplying apparatus as claimed in claim 4, further comprising an elevating mechanism for raising and lowering a bottom plane of the component installment part with respect to the blowout port.

9. The component supplying apparatus as claimed in claim 1, further including another blowout port, wherein one blowout port is situated at a bottom plane of the component installment part and the other blowout port is situated at the sidewall of the component installment part.

10. The component supplying apparatus as claimed in claim 9, further including a step part formed at the sidewall of the component installment part, wherein the step part is situated between the two blowout ports of the component installment part.

11. A component supplying method using a component supplying apparatus including a component installment part, a blowout port, and a component supply part, the method comprising the steps of:
installing one or more components in the component installment part;
blowing air into the component installment part from an opening of the blowout port; and
guiding the components into the component supply part from the component installment part by the air from the blowout port;
wherein the component supply part is provided in communication with an upper end part of a sidewall of the component installment part.

12. The component supplying method as claimed in claim 11, wherein a clearance is provided in the vicinity of the upper end part of the sidewall of the component installment part for releasing a portion of the air from the blowout port.

13. The component supplying method as claimed in claim 11, wherein the component installment part has a funnel shape, wherein the blowout port is situated at a bottom plane of the component installment part.

14. The component supplying method as claimed in claim 11, wherein the component installment part has a cylindrical shape, wherein the blowout port is situated at the sidewall of the component installment part.

15. The component supplying method as claimed in claim 11, wherein the component supply part that is situated at a position to which a tangential line of an inner circular peripheral of the component installment part extends.

16. The component supplying method as claimed in claim 11, wherein the component supply part is situated at a position to which a normal line of an inner circular peripheral of the component installment part extends.

17. The component supplying method as claimed in claim 14, wherein a space area is at a position lower than the opening of the blowout port.

18. The component supplying method as claimed in claim 14, further comprising an elevating mechanism for raising and lowering a bottom part of the component installment part with respect to the blowout port.

19. The component supplying method as claimed in claim 11, further including another blowout port, wherein one blowout port is situated at a bottom part of the component installment part and the other blowout port is situated at the sidewall of the component installment part.

20. The component supplying apparatus as claimed in claim 19, further including a step part formed at the sidewall of the component installment part, wherein the step part is situated between the two blowout ports of the component installment part.

21. A component supplying apparatus comprising:
an apparatus body including a top plate and a component installment part for installing one or more components therein;
a blowout port including an opening from which air is blown into the component installment part;
a lid member provided above the component installment part;
a component supply part into which the components are guided from the component installment part by the air from the blowout port;
wherein the component supply part is provided in communication with an upper end part of a sidewall of the component installment part.

22. The component supplying apparatus as claimed in claim 21, wherein a clearance is provided between the lid member and the top plate of the apparatus body for releasing a portion of the air from the blowout port.

23. The component supplying apparatus as claimed in claim 21, wherein the component installment part has a funnel shape, wherein the blowout port is situated at a bottom part of the component installment part, wherein the opening of the blowout port has a slit shape.
